(19) United States
(12) Patent Application Publication
(10) Pub. No.: US 2011/0199630 A1
(43) Pub. Date: Aug. 18, 2011

(54) PRINTER AND PRINTING METHOD USING THE SAME

(75) Inventor: Shuji Oozawa, Shizuoka (JP)

(73) Assignee: TOSHIBA TEC KABUSHIKI KAISHA, Tokyo (JP)

(21) Appl. No.: 12/870,106

(22) Filed: Aug. 27, 2010

(30) Foreign Application Priority Data
Feb. 17, 2010 (JP) 2010-032979

(51) Int. Cl. G06K 15/00

(52) U.S. Cl. 358/1.14

(57) ABSTRACT

A printer includes a memory configured to store a message to be displayed in a help display mode to handle an error detected in an execution mode and to store a setting mode in which a setting program associated with the message is performed, a display configured to display the message, an operation unit configured to receive a user's operation, and a mode switching unit configured to switch an operation mode from the help display mode to the setting mode associated with the message if the operation unit receives a specified operation while the message is displayed in the help display mode.

### CROSS-REFERENCE TO RELATED APPLICATIONS

This application is based upon and claims the benefit of priority from Japanese Patent Application No. 2010-032979, filed on Feb. 17, 2010, the entire contents of which are incorporated herein by reference.

### FIELD

Embodiments described herein relate generally to a printer and a printing method using the same.

### BACKGROUND

Conventionally, there are printers for printing barcodes on a paper sheet such as a label, which display help messages, in case errors occur, including user's countermeasures against errors on a LCD or other types of displays.

In this regard, as the user's countermeasures against the errors, it is sometimes required to perform specified settings after removing causes of the errors according to the help messages displayed on the display. For example, if a paper jam occurs, a help message related to the paper jam is displayed on the display. After resolving causes of the paper jam according to the help message, a user often should perform a resetting of a sensor for detecting a position of a conveyed sheet of paper.

In this case, it is necessary to terminate displaying the help message on the display and then return to a system screen for inputting requests for switching to various operation modes. Thereafter, it is also necessary to perform selection operations for switching to a setting mode in which a specified setting is carried out. Thus, complicated operations are required for a user to switch the printer from the state in which the help message has been displayed on the display to the setting mode in which the specified setting is carried out.

### BRIEF DESCRIPTION OF THE DRAWINGS

FIG. 1 is a perspective view showing the outward appearance of a printer according to one embodiment.

FIG. 2 is a perspective view showing the outward appearance of a printer whose cover is in an open state.

FIG. 3 is a schematic diagram showing a paper conveying path.

FIG. 4 is a block diagram showing a control system of a printer.

FIG. 5 is a block diagram showing the configuration of a printer control unit.

FIG. 6 is a flowchart illustrating one example of printer operations.

FIG. 7 is a view illustrating different examples of images displayed on a display/operation unit.

FIG. 8 is a perspective view showing the external appearance of a printer according to one embodiment.

FIG. 9 illustrates a display and an operation unit of the printer.

### DETAILED DESCRIPTION

According to one embodiment, a printer includes a memory configured to store a message to be displayed in a help display mode to handle an error detected in an execution mode and to store a setting mode in which a setting program associated with the message is performed, and a display configured to display the message. The printer further includes an operation unit configured to receive a user's operation, and a mode switching unit configured to switch an operation mode from the help display mode to the setting mode associated with the message if the operation unit receives a specified operation while the message is displayed in the help display mode.

Embodiments of a printer and a program will now be described in detail with reference to the accompanying drawings. The embodiments disclose an exemplary thermal-type printer including a paper roll wound with a label paper, which has a plurality of labels adhered to a backing sheet, and printing barcodes by a thermal head. The printer disclosed in the embodiments is not limited to the above mentioned thermal-type printer but may include an inkjet-type printer.

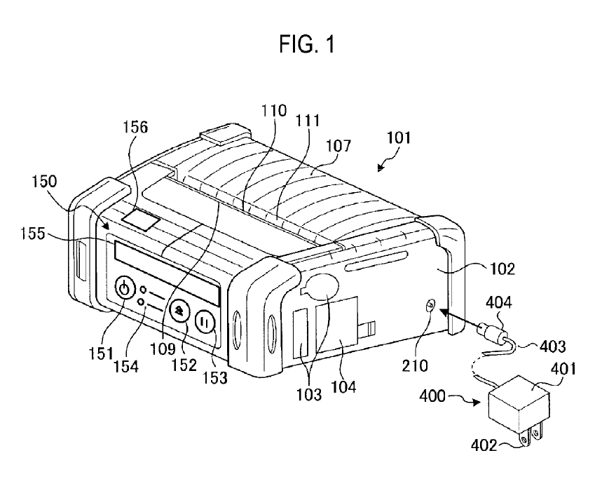

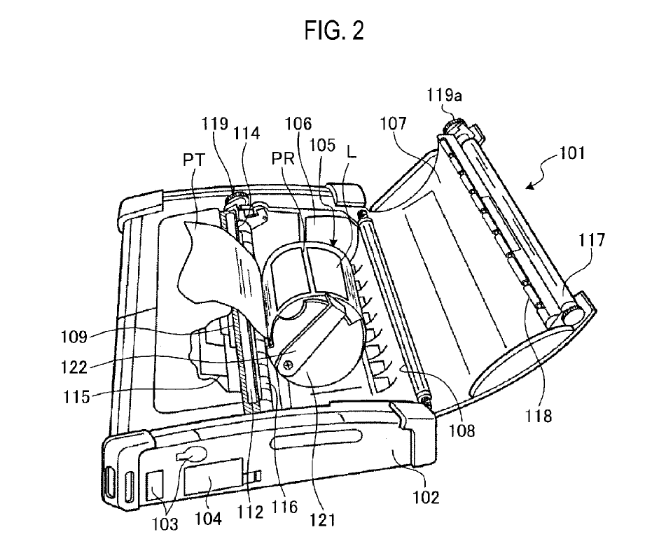

The schematic structure of a printer will be described with reference to FIGS. 1 and 2. FIG. 1 is a perspective view showing the outward appearance of a printer 101, and FIG. 2 is a perspective view showing the outward appearance of the printer 101 whose cover is in an open state.

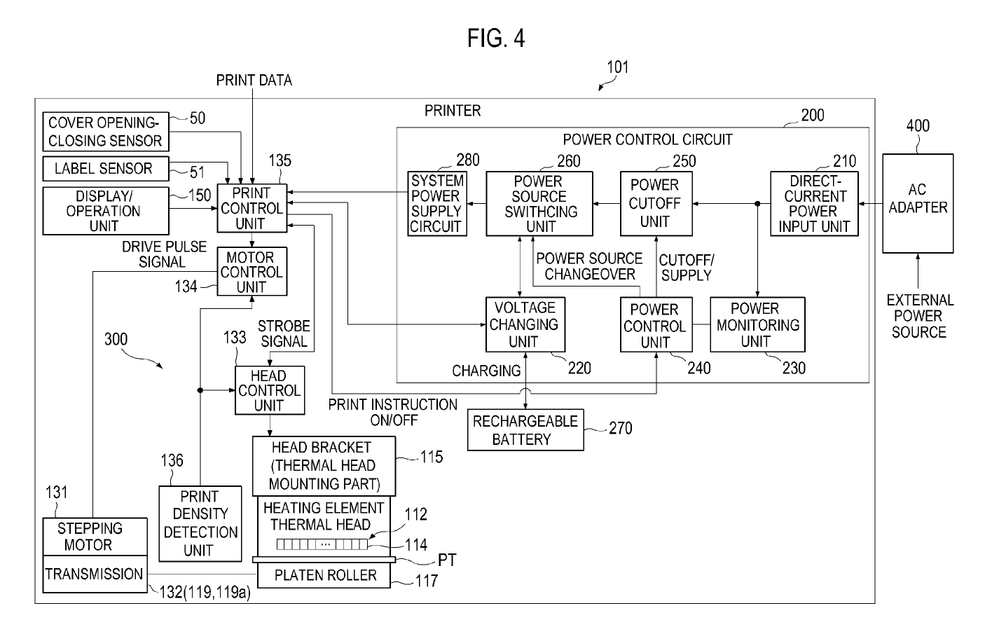

The printer 101 has a rectangular parallelepiped shape. The printer 101 includes a print mechanism 300 (see FIG. 4) to carry out a printing function and a paper feeding function, a rechargeable battery 270 (see FIG. 4) for supplying power in a housing 102. In one embodiment, the rechargeable battery 270 may be a lithium-ion battery. The housing 102 has an internal structure to store a paper roll PR wound with a label paper PT, which has a plurality of labels L (see FIG. 2) adhered to a backing sheet. An opening 106 is defined on the upper surface of the housing 102 so that the roll PR can be introduced into the housing 102 through the opening 106. A cover 107 is pivotably arranged in the opening 106. The cover 107 may open or close, which causes the opening 106 to be in an open state or a closed state.

Further, the housing 102 includes a cover opening-closing sensor 50 (see FIG. 4) for detecting the open state and the closed state of the cover 107. The cover opening-closing sensor 50 may include a micro-switch, which is one type of mechanical sensor. When the cover 107 is opened from the housing 102 to make the opening 106 open, the cover opening-closing sensor 50 comes into an off-state in which no electric current flows. On the other hand, if the cover 107 covers the opening 106, the cover opening-closing sensor 50 comes into an on-state in which electric current flows. The cover opening-closing sensor 50 is not limited to the above mentioned micro-switch, but may include a contactless switch provided with a photo sensor or other switches.

The cover 107 is attached to an inner side 108 of the housing 102 defining one side of the opening 106. When the cover 107 is in a closed state, a slot for discharging a printed label paper PT is formed between the outer side 111, i.e., the front end of the cover 107, and the front side 109, i.e., one side of the opening 106. This slot extends in the transverse direction of the printer 101 and serves as a paper outlet 110.

On one lateral surface of the housing 102, there are arranged a connector portion 103 including a variety of connectors (e.g., a universal serial bus (USB) connector) and a battery storage portion 104 for detachably enclosing the rechargeable battery 270.

The front side 109 of the housing 102 or the outer side 111 of the cover 107, respectively defining the paper outlet 110, has a sharp-edged shape to cut the label paper PT discharged from the paper outlet 110.

The housing 102 includes a paper storage portion 105 for detachably enclosing the paper roll PR. The paper roll PR is enclosed in the paper storage portion 105 with a roll shaft oriented in the transverse direction of the printer 101. The paper roll PR is unwound to be conveyed toward the paper outlet 110 by a platen roller 117 (see FIG. 1). A thermal head 112 is arranged opposite the platen roller 117.

The thermal head 112 is detachably mounted to a head bracket 115, which is arranged in the lower portion. The head bracket 115 is fixed to the housing 102 to abut against the thermal head 112 in the upper inner direction of the printer 101. A head cover 116 is arranged near the thermal head 112 at an inner portion of the printer 101. The head cover 116 is selectively mounted to the housing 102, thereby abutting against the thermal head 112 to prevent the thermal head 112 from vibrating.

The thermal head 112 includes a plurality of heating elements 114 arranged in a row with a certain density. As the heating elements 114 generate heat under the control of a head control unit 133 (see FIG. 4), the thermal head 112 prints by heating the labels L of the label paper PT. The thermal head 112 with e.g., 200 dpi or 300 dpi is mounted to the head bracket 115.

A driving gear 119 is arranged within the housing 102. The driving gear 119 is turned by a stepping motor 131 (see FIG. 4) used as a drive power source, which is operated under the control of a motor control unit 134 (see FIG. 4).

A paper pressing roller 118 is arranged near the platen roller 117 in the cover 107. The platen roller 117 and the paper pressing roller 118 are rotatable along their rotation axes extending in the transverse direction of the printer 101.

The platen roller 117 is arranged at a position in the cover 107, where it can make contact with the heating elements 114 of the thermal head 112 when the cover 107 is in the closed state. The platen roller 117 is coupled with a driven gear 119a on the left side of the platen roller 117, when viewed from the front side of the printer 101, so as to rotate together.

The driven gear 119a is engaged with the driving gear 119 so as to be driven by the driving gear 119, when the cover 107 comes into the closed state. The paper pressing roller 118 is coupled to the cover 107 at such a position that it can make contact with the head cover 116 when the cover 107 is in the closed state. When the cover 107 is closed, the driven gear 119a mounted to the cover 107 is engaged with the driving gear 119, thus rotationally driving the platen roller 117 coupled to the driven gear 119a. In the present embodiment, the driving gear 119 and the driven gear 119a serve as a transmission 132 (see FIG. 4).

In the present embodiment, the paper roll PR is arranged within the paper storage portion 105 in such a fashion that it can be attached or detached by a lever 122. The paper roll PR is positioned between two guide fences 121. The space between the two guide fences 121 can be adjusted in accordance with the width of the paper roll PR.

The housing 102 includes a direct current (DC) power input unit 210 for inputting DC power from an external power source. A plug 404 of an AC adapter 400 is inserted into the DC power input unit 210, so that DC power is supplied to the printer 101.

The AC adapter 400 is provided separately from the printer 101. The AC adapter 400 is inserted into an external commercial power socket to output DC power from the plug 404. The AC adapter 400 includes a main body 401 provided with a DC conversion circuit, a socket plug 402 attached to the main body 401, a cable 403 to output DC power, and a cable plug 404. The AC adaptor 400 converts the electric power of, e.g., AC 100V, inputted from the socket plug 402 to the electric power of, e.g., DC 20V, which is then outputted to the cable plug 404 provided at the tip end of the cable 403.

Besides a general-purpose AC adapter, a car adapter (with input power and output power of 12V), a DC-DC converter (with input power of 10V to 60V and output power of 20V) may be used as the device for supplying DC power to the DC power input unit 210. If the plug 404 is connected to the DC power input unit 210, DC power is supplied to the printer 101 to drive the printer 101 or charge the rechargeable battery 270.

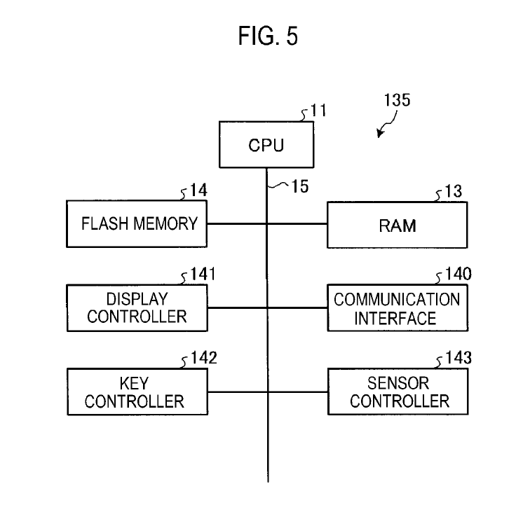

The housing 102 also includes a display/operation unit 150. The display/operation unit 150 includes a power switch 151, a paper feeding button 152 for allowing a user to instruct paper feeding, a pause button 153 (PAUSE key) for allowing a user to instruct temporary stoppage of the paper feeding. The display/operation unit 150 further includes a decision/cancel button 154 (ENTER key or CANCEL key) for the user to instruct decision or cancellation, a liquid crystal display (LCD) 155 and a communication window 156. The buttons and switches included in the display/operation unit 150 may be implemented in the form of mechanical input devices, but may not be limited thereto. In some embodiments, the display/operation unit 150 may be implemented in form of a touch screen. In this case, the buttons and switches included in the display/operation unit 150 may be implemented in graphical interface objects displayed on the display/operation unit 150. In general, the printer 101 may communicate data with an external device through infrared communication via the communication window 156 and a communication interface 140 (see FIG. 5) or data communication via the connector portion 103 and the communication interface 140. For example, through communicating data, the printer 101 may receive print data such as barcodes from an external device and store print data in a random access memory (RAM) 13 or a flash memory 14 (see FIG. 5) for printing. For example, an external device may include a personal computer (PC), a cellular phone, a handy terminal and an information device designed to perform a variety of arithmetic processes in response to operations input by a user.

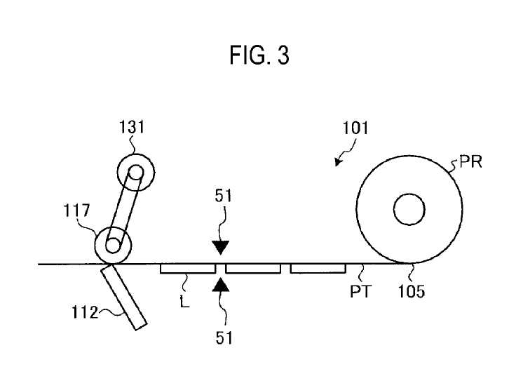

In the following, a paper conveying path extending between the paper storage portion 105 and the thermal head 112 will be described with reference to FIG. 3. FIG. 3 is a schematic view showing the paper conveying path.

As shown in FIG. 3, a label sensor 51 for detecting the position of a label paper being conveyed is arranged in a paper conveying path. The paper conveying path extends between the paper storage portion 105 and the thermal head 112. For example, the label sensor 51 is a photo sensor using light intensity to detect the positions of the labels L adhered to the backing sheet of the label paper PT. The label sensor 51 may be a transmission-type sensor for detecting the gap between the labels L adhered to the backing sheet of the label paper PT or a reflection-type sensor for detecting the labels L adhered to the backing sheet of the label paper PT. The label sensor 51 is connected to a printer control unit 135 (see FIG. 4). The printer control unit 135 compares the output value of the label sensor 51 with a predetermined threshold value (or a preset value) to distinguish the light intensity, so as to detect the labels L. In addition to detecting the positions of the labels L being conveyed, the label sensor 51 may detect black marks preliminarily provided on the label paper for printing at a specified position.

Next, the control system of the printer 101 will be described. FIG. 4 is a block diagram showing the control system of the printer 101.

As shown in FIG. 4, the print mechanism 300 of the printer 101 includes a head control unit 133 for outputting print control signals including a strobe signal and a print signal to the thermal head 112, and a motor control unit 134 for outputting a drive pulse signal to the stepping motor 131. The printer control unit 135 controls all components of the printer, including the cover opening-closing sensor 50, the label sensor 51, the display/operation unit 150 and the print mechanism 300.

The print mechanism 300 of the printer 101 includes a print density detection unit 136 to detect whether the thermal head 112 mounted to the head bracket 115 has a print density of 200 dpi or 300 dpi.

FIG. 5 is a block diagram showing the configuration of the printer control unit 135. As shown in FIG. 5, the print control unit 135 includes a CPU (central processing unit) 11 to perform various kinds of arithmetic processing to centrally control the respective components. A RAM 13 and a flash memory 14, i.e., a non-volatile memory capable of keeping stored contents despite interruption of electric power, are connected to the CPU 11 through a system bus 15.

The flash memory 14 stores operation programs and a variety of setting information of the printer 101. The CPU 11 deploys the operation programs stored in the flash memory 14 to the working area of the RAM 13, and executes the operation programs to control each component. The operation programs include a program used to display help messages on the LCD 155. The variety of setting information includes data regarding the help messages displayed on the LCD 155 (e.g., a help message table).

The RAM 13 temporarily stores a variety of variable information. For example, a partial area of the RAM 13 is used as a print buffer to which the print data (image data) to be printed on the labels L of the label paper PT are deployed. The print data, i.e., the data to be printed, may be received from an external device. The print data may be stored in the flash memory 14.

The CPU 11 is connected to a communication interface 140, a display controller 141, a key controller 142 and a sensor controller 143, via the system bus 15. Under the control of the CPU 11, the display controller 141 controls the display (e.g., a remaining battery level, radio wave reception conditions or the detection result of the label sensor 51) on the LCD 155 of the display/operation unit 150. Under the control of the CPU 11, the key controller 142 controls the key inputs received from the power switch 151, the paper feeding button 152, the pause button 153 of the display/operation unit 150. Under the control of the CPU 11, the sensor controller 143 controls the inputs received from sensors such as the cover opening-closing sensor 50 and the label sensor 51.

The communication interface 140 communicates with an external device such as a host computer via the connector portion 103 or the communication window 156. The communication interface 140 may include e.g., an infrared communication tool such as an IrDA, a USB (Universal Serial Bus), a wireless LAN (Local Area Network), a RS-232C and Bluetooth (registered trademark). The communication interface 140 may communicate with a communication interface provided in the host computer.

Referring back to FIG. 4, the printer 101 further includes a power control circuit 200 arranged within the housing 102. Responsive to the on/off operation of the power switch 151 of the operation part 150, the power control circuit 200 performs software-control of the supply and cutoff of the electric power supplied from the external commercial power socket through the AC adapter 400 or the electric power supplied from the rechargeable battery 270. The term “software-control” refers to controlling the supply and cutoff of the electric power based on the control signals of the portable printer 101.

The power control circuit 200 includes a DC power input unit 210, a voltage converting unit 220, a power monitoring unit 230, a power control unit 240, a power cutoff unit 250, a power source switching unit 260 and a system power supply circuit 280.

The voltage converting unit 220 converts the voltage of the DC power from the DC power input unit 210 in a certain voltage range (e.g., 10V to 25V) to a voltage appropriate for recharging the rechargeable battery 270 (e.g., a voltage of 8.4V or 16.8V, which varies depending on the specifications of the rechargeable battery 270). In one embodiment, the rechargeable battery 270 is a lithium-ion battery. The rechargeable battery 270 performs its recharging operation in a CC/CV recharging method, namely in a constant current and constant voltage recharging method, by dropping the DC voltage supplied from outside.

When the recharging operation is performed, the voltage converting unit 220 may set a long-lifespan mode for prolonging the battery lifespan by varying the recharging voltage and current or by adjusting the recharge threshold value. The power monitoring unit 230 monitors the voltage of the DC power from the DC power input unit 210. The power cutoff unit 250 cuts off the DC power from the DC power input unit 210, if the voltage of the DC power detected by the power monitoring unit 230 falls outside a predetermined range (e.g., a range of 10V to 25V). The power source switching unit 260 switches the power supplied to the system power supply circuit 280, to the power supplied from the DC power input unit 210 or the power supplied from the rechargeable battery 270.

The power control unit 240 performs the control of the power cutoff unit 250 and the power source switching unit 260, as described below. If the power monitoring unit 230 detects that the DC power supplied from the DC power input unit 210 falls within a predetermined range (e.g., 10V to 25V), the power source switching unit 260 operates to allow the DC power from the DC power input unit 210 to flow into the voltage converting unit 220. The voltage converting unit 220 supplies the DC power for recharging (e.g., 8.4V) to the rechargeable battery 270. Similarly, the DC power from the DC power input unit 210 also flows into the system power supply circuit 280.

Upon receiving a print signal from the printer control unit 135 when the DC power is supplied from outside to the DC power input unit 210, the power control unit 240 operates the power source switching unit 260 to supply the power of the rechargeable battery 270 to the drive power for the print mechanism 300. Thereby, when a print instruction is received, the power supplied from the DC power input unit 210 to the print mechanism 300 is cut off. However, if the voltage of the DC power supplied from the DC power input unit 210 falls within a predetermined range, the power may be supplied from the DC power input unit 210 to the printer control unit 135.

Even when no print instruction is received, if the voltage of the DC power detected by the power monitoring unit 230 is lower than the voltage of the rechargeable battery 270, the power control unit 240 operates the power source switching unit 260 to supply the power from the rechargeable battery 270 to the system power supply circuit 280.

The system power supply circuit 280 supplies the power to each component, such as the print mechanism 300, the cover opening-closing sensor 50, the label sensor 51 and the display/operation unit 150, through the printer control unit 135. The electric power within the allowable range of voltage is applied to the thermal head 112 of the print mechanism 300. In other words, when the printer 101 prints, the electric power cutoff unit 250 cuts off the electric power supplied from the DC power input unit 210, and the power source switching unit 260 allows the electric power from the rechargeable battery 270 to be supplied to the thermal head 112, so that a voltage greater than the allowable voltage is not supplied to the thermal head 112.

The system power supply circuit 280 supplies electric power (e.g., voltage of 5V, 3.5V, 3.3V or 1.5V) to drive the printer control unit 135, the cover opening-closing sensor 50, the label sensor 51, the display/operation unit 150 and so forth. In the system power supply circuit 280, respective operation input voltages to be fed to the respective units are set so as to ensure that the respective units can properly operate within the range of the voltages of the external DC power or the rechargeable battery 270.

The system power supply circuit 280 performs the on/off control of the individual power systems that are driven by the DC power supplied from the rechargeable battery 270 and the DC power input unit 210. In other words, if the DC power input unit 210 is supplied with DC power, the system power supply circuit 280 allows DC power to flow from the DC power input unit 210 to the printer control unit 135. In contrast, if the DC power input unit 210 is not supplied with DC power, the system power supply circuit 280 allows DC power to flow from the rechargeable battery 270 to the printer control unit 135.

If the power control unit 240 allows DC power to flow from the rechargeable battery 270 to the printer control unit 135, the system power supply circuit 280 supplies the DC power to the print mechanism 300 via the printer control unit 135.

In addition to controlling of the print mechanism 300, the printer control unit 135 acquires information delivered from the voltage converting unit 220 and the system power supply circuit 280 during the power supplying period and transmits a charge startup instruction to the power control unit 240 if the voltage converting unit 220 and the system power supply circuit 280 are in a charge-permitting state.

The printer control unit 135 also serves as a mode switching unit by switching the operation mode of the printer 101 among various operation modes based on a user's operation inputted through the display/operation unit 150 or device states such as whether the external DC power is being supplied to the device. Examples of the operation modes include an in-line mode, an on-line mode, a help display mode, a sleep mode, a print mode, a charge mode, a long-lifespan charge mode and a setting mode.

The in-line mode refers to an operation mode in which printing is directly performed by the thermal head 112. The on-line mode denotes an operation mode in which upon the user's operation being inputted through the display/operation unit 150, processes corresponding to the user's operation are performed. The help display mode signifies an operation mode in which the help messages pre-stored in the flash memory 14 are displayed on the LCD 155. The sleep mode indicates an operation mode in which the system stays in an energy-saving state to reduce power consumption. The print mode stands for an operation mode in which printing is performed by the thermal head 112. The charge mode is an operation mode in which the rechargeable battery 270 is charged with electric power. The long-lifespan charge mode is an operation mode in which charging is performed at a low voltage without shortening the lifespan of the rechargeable battery 270. The setting mode is an operation mode in which the printer 101 is subjected to various kinds of settings. Examples of the setting mode include a sensor setting mode in which to perform settings of various kinds of sensors such as the cover opening-closing sensor 50 and the label sensor 51, a power setting mode in which settings are performed in connection with power control, e.g., a switching setting between the charge mode or the long-lifespan charge mode, and a print setting mode in which adjustments of print density of the thermal head 112 or driving the stepping motor 131 are performed.

Switching to the respective modes is controlled in the following manner. When driven by the rechargeable battery 270, the printer 101 goes into the sleep mode after a specified time has lapsed in the in-line mode. In the sleep mode, unnecessary power supplied to the functional units is cut off and the communication interface 140 alone is ready to receive signals in a standby state. The printer 101 in the sleep mode comes back to the normal in-line mode if there is a need to operate the print mechanism 300 or if signal transmission or reception occurs in the communication interface 140 during the sleep mode.

When supplied with external DC power, the printer 101 does not come into the sleep mode while staying in the normal in-line mode. This makes it possible to rapidly start up the print mode. In the in-line mode, the communication interface 140 is ready to receive signals in a standby state and the voltage converting unit 220 performs charge control of the rechargeable battery 270. The printer 101 goes into the on-line mode if a specified user's operation is inputted through the display/operation unit 150 during the in-line mode. In the on-line mode, the printer 101 may enter the setting mode such as the sensor setting mode, the power setting mode or the print setting mode in response to the user's operation inputted through the display/operation unit 150. The printer 101 goes back to the in-line mode if a specified user's operation is inputted through the display/operation unit 150 during the on-line mode. If an error is detected during the execution mode such as the in-line mode or the on-line mode, the printer 101 enters the help display mode to display the help message corresponding to the type of error. Alternatively, the printer 101 may enter the help display mode in response to the user's operation performed during the on-line mode.

In the printer 101 described above, the paper roll PR is put into the paper storage portion 105 and the label paper PT is discharged. If the cover 107 is closed in that state, the discharged label paper PT is interposed between the thermal head 112 and the platen roller 117 as well as between the head cover 116 and the paper pressing roller 118. If the printer 101 goes into the print mode under the control of the printer control unit 135 in this state, the stepping motor 131 is driven by the control of the motor control unit 134. In response, the label paper PT is conveyed from the paper roll PR toward the paper outlet 110 through the thermal head 112. The thermal head 112 causes the heating elements 114 to generate heat under the control of the head control unit 133, thereby printing a certain content on the labels L of the label paper PT being conveyed.

In the setting mode, various types of settings for the printer 101 are performed in response to the user's operation inputted through the display/operation unit 150. The printer 101 goes back to the on-line mode if a specified user's operation is inputted through the display/operation unit 150 during the setting mode. In the help display mode, the help message corresponding to the type of detected error is read from the flash memory 14 and displayed on the LCD 155. The printer 101 goes back to the on-line mode if a cancel instruction is inputted through the decision/cancel button 154 during the help display mode.

The operation mode is changed over to the setting mode associated with the help message if the user performs a preset specific operation (e.g., the operation of the pause button 153) in the help display mode. In other words, if a specific operation such as the operation of the pause button 153 is performed while the help message is displayed on the LCD 155 during the help display mode, the operation mode is changed over to the setting mode associated with the displayed help message without going through the on-line mode. Therefore, in the printer 101 set forth above, when the help message is displayed, a user is able to easily operate the printer 101 to enter the setting mode associated with the displayed help message.

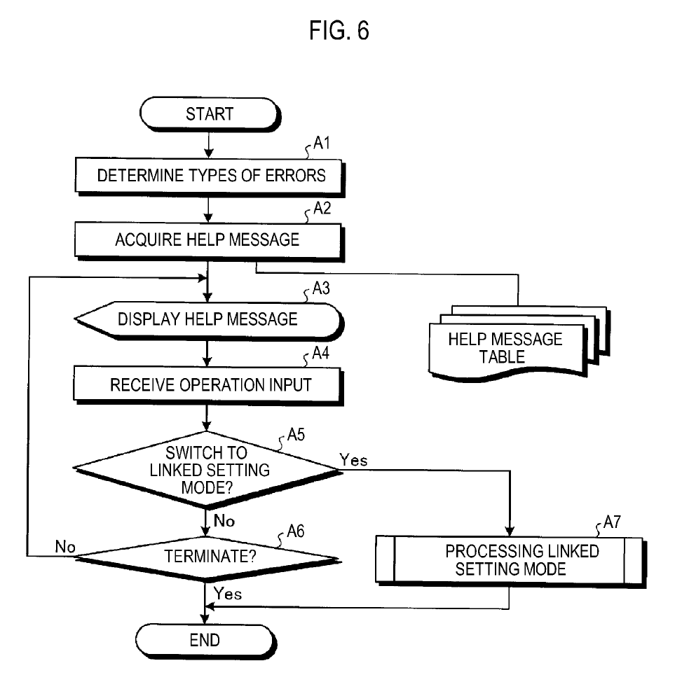

One example of the operations of the printer 101 executed and implemented by the CPU 11 according to the program stored in the flash memory 14 will be described with reference to the flowchart shown in FIG. 6. More specifically, description will be made regarding the display of the help message and a series of acts relating to the switch to the setting mode associated with the help message when an error is detected during the in-line mode or the on-line mode.

As shown in FIG. 6, if the processing is started, the CPU 11 (serving as a determination unit) determines the types of the errors detected in the printer 101 during the execution mode such as the in-line mode or the on-line mode (act A1). More specifically, the CPU 11 transmits control signals (e.g., the drive pulse signals or the print control signals) to respective units of the printer 101 and monitors the operation state of the printer 101 based on signals which are returned from the respective units in response to the control signals. The CPU 11 determines the type of error detected in the operation state and then outputs an error code indicative of the determined error type.

For example, if the electric power requested by the power control circuit 200 is not supplied from the system power supply circuit 280, the CPU 11 outputs an error code showing that the error type is associated with the electric power. Therefore, if the error code associated with the electric power is outputted in the course of driving the rechargeable battery 270, it may indicate an insufficient charge of the rechargeable battery 270. If the stepping motor 131 is not operated by the drive pulse signal supplied from the motor control unit 134, the CPU 11 outputs an error code showing that the error type is associated with the jam of the label paper PT (or a paper jam). If an error signal is outputted from the head control unit 133 while the printing (or heating) instruction to the thermal head 112 is not performed as normal despite a print control signal from the head control unit 133, the CPU 11 outputs an error code showing that the error type is associated with the printing. The error types as noted above are presented by way of example only. Other examples of the error types include an operation error detected when a print instruction is inputted through the display/operation unit 150 while the cover opening-closing sensor 50 detects the open state of the cover 107.

Then, the CPU 11 acquires the help message corresponding to the error type determined in act A1 and the information relating to the setting mode associated with the help message by referring to the help message table pre-stored in the flash memory 14 (act A2).

The help message table is a data table that stores the help messages corresponding to the respective error types and the information linked to the setting modes associated with the respective help messages. More specifically, for an error code of each error (such as the error associated with electric power, the error associated with paper jams, or the error associated with the printing), a help message describing a countermeasure against the error and link information to a setting mode to enter (after the causes of the error are resolved according to the help message) are stored in the help message table. The link information may be a start address of a setting program that performs a processing of the setting mode. The help message corresponding to the respective error type contains the information on the associated setting mode which is to be performed after the causes of the error are resolved according to the help message and an operation method for switching to the setting mode (e.g., pressing down the pause button 153 for a long time).

Subsequently, the CPU 11 displays the help message acquired in act A2 on the LCD 155 (act A3) and receives the user's operation input from the display/operation unit 150 (act A4). Then, the CPU 11 determines whether the user's operation input received in act A4 is an operation input instructing a switch to the setting mode linked to the help message and whether to switch to the setting mode linked to the help message (act A5).

For example, if an operation input instructing a switch to the setting mode linked to the help message is made by pressing the pause button 153 down (in case of “Yes” in act A5), the CPU 11 advances the processing to act A7. If the operation input is an instruction to display the next page or the preceding page of the help message which may not be wholly displayed at once on the LCD 155 or if the operation input is an instruction to terminate the display of the help message (in case of “No” in act A5), the CPU 11 advances the processing to act A6.

In act A6, the CPU 11 determines whether the user's operation input received in act A4 is an instruction to terminate the display of the help message and whether to terminate the processing (act A6). If the user's operation input is an instruction to terminate the display of the help message (in case of “Yes” in act A6), then the processing is terminated. On the other hand, if the user's operation input is not an instruction to terminate the display of the help message but an instruction to display the next page or the preceding page of the help message, the processing returns to act A3 to display the instructed page on the liquid crystal display 155.

In act A7, in response to the operation input instructing the switch to the setting mode linked to the help message, the CPU 11 starts up the setting program for performing the processing of the linked setting mode. Thus, the CPU 11 performs the processing of the setting mode (act A7) and then terminates the processing.

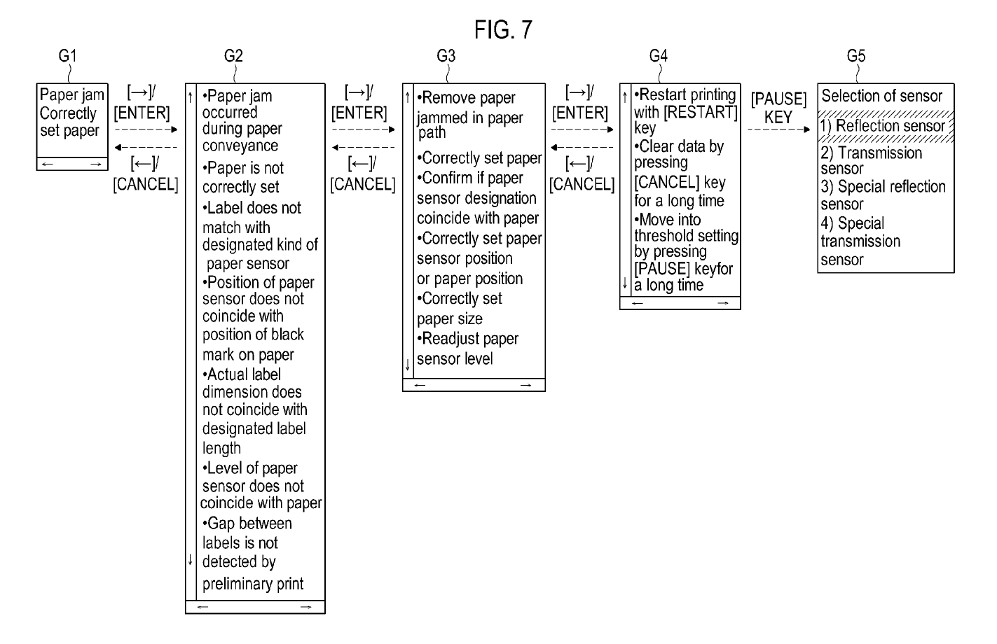

FIG. 7 is a view illustrating examples of images G1 through G5 displayed on the display/operation unit 150. More specifically, the images G1 through G4 refer to the images displayed on the LCD 155 in act A3, which contain the help messages available when the type of error is a paper jam. The image G5 is the image displayed on the LCD 155 while processing the linked setting mode in act A7.

As illustrated in FIG. 7, in act A3, the images G1 through G4 containing help messages are displayed on the LCD 155 in response to the operation (ENTER/CANCEL) of the decision/cancel button 154. For example, if the CANCEL operation is performed by pressing the decision/cancel button 154 while the image G2 is displayed, the image G1 containing the preceding page of the help message is displayed on the LCD 155. On the other hand, if the ENTER operation is performed by pressing the decision/cancel button 154 while the image G2 is displayed, the image G3 containing the next page of the help message is displayed on the LCD 155.

The help messages displayed in act A3 contain the information describing the setting mode associated with the help messages, the operation method for switching to the setting mode (e.g., the image G4) and so on. As the linked setting mode, the sensor setting mode is linked to the help message in case the type of error is a paper jam. After resolving the causes of error according to the help message, the user performs the displayed operation method (pressing the pause button 153 down for a long time) in act A4. This may allow the user to easily perform the switch to the sensor setting mode (the display of the image G5), namely the setting mode associated with the help message, without having to return to the on-line mode.

Referring to FIG. 1, the images displayed on the display/operation unit 150 and the detailed processes by CPU 11, in case the user's operations are received in acts A3 to A5, will be described.

In the help display mode showing the help message, the paper feeding button 152 may serve as an upward arrow key button for scrolling the screen upward. The pause button 153 may serve as a downward arrow key button for scrolling the screen downward. Namely, in the help display mode showing the help message, the CPU 11 scrolls the screen upward when detecting a press of the paper feeding button 152 and alternatively scrolls the screen downward when detecting a press of the temporary stop button 153. In the following description of the help display mode, the paper feeding button 152 is referred to as the paper feeding button (upward arrow key button) 152 and the pause button 153 is referred to as the pause button (downward arrow key button) 153.

First, when the CPU 11 detects the paper jam error, the help message acquired in act A2, i.e. the image G1, is displayed on the LCD screen of the display/operation unit 150 (act A3). Then, the CPU 11 receives the user's operation inputted through the display/operation unit 150 (act A4). At this time, on the display/operation unit 150, a message including “PAPER JAM” and “Correctly set paper” (as illustrated in the image G1) is displayed over 3 lines. If the CPU 11 detects the decision button 154 ([ENTER] key) being pressed in the display/operation unit 150 while the image G1 is displayed thereon, the image G1 is switched to the image G2 and the CPU 11 displays the message of the image G2 on the screen of the display/operation unit. For example, the first to the fourth lines of message, i.e., including “•Paper jam occurred during paper conveyance” are displayed on the display/operation unit 150.

Although for sake of explanation, the entire message is illustrated in the image G2 of FIG. 7, the actual screen displayed on the display/operation unit 150 may show, for example, only the top four lines. Therefore, if the length of the message to be displayed on the display/operation unit 150 is more than the four lines, the screen may be scrolled to show the subsequent line (e.g., the fifth line) upon detecting the press operation of the pause button (downward arrow key button) 153. For example, if the CPU 11 detects that the pause button (downward arrow key button) 153 is pressed down once while the image G2 (the first to the fourth lines) is displayed on the display/operation unit 150, the message is scrolled by 1 line so that the second to the fifth lines of the message, i.e., including “occurred during paper conveyance” and “•Paper is not,” are displayed on the display/operation unit 150.

On the other hand, if the user wants to display again the previous line of the message, i.e., the first line including “•Paper jam,” in case the second to the fifth lines of the message are already displayed, the user may press the paper feeding button (upward arrow key button) 152 down once. If the CPU 11 detects the press of the paper feeding button (upward arrow key button) 152, the screen is scrolled upward by 1 line to show the first to the fourth lines again on the display/operation unit 150.

When the CPU 11 detects a press of the decision button 154 ([ENTER]) while the image G2 is displayed on the screen, the image G2 is switched to the image G3 on the display/operation unit 150. In such case, on the display/operation unit 150, the first to the fourth line of the messages of the image G3, i.e., including “•Remove paper jammed in paper path” and “•Correctly set paper,” are displayed on the screen.

In this regard, as described above, the subsequent lines of the messages may be displayed when the user presses the pause button (downward arrow key button) 153. If the CPU 11 detects the press of the pause button (downward arrow key button) 153, the screen is scrolled to show the subsequent lines of the messages.

When the CPU 11 detects a press of the cancel button 154 ([CANCEL]) while the image G3 is displayed on the screen, the image G3 is switched back to the image G2 on the display/operation unit 150.

When the CPU 11 detects a press of the decision button 154 ([ENTER]) while the image G3 is displayed on the screen, the image G3 is switched to the image G4 on the display/operation unit 150. In such case, the CPU 11 displays four lines of messages (the first to the fourth lines) of the image G4, i.e., including “•Restart printing with [RESTART] key” and “•Clear data by,” on the screen. In this case, when the CPU 11 detects a press of the cancel button 154 ([CANCEL]) while the image G4 is displayed on the screen, the image G4 is switched back to the previous image G3 so that the image G3 is displayed on the screen.

When the CPU 11 detects that the pause button ([PAUSE] key) 153 is pressed for a long time (i.e. when the CPU 11 detects that the pause button (downward arrow key button) 153 is pressed for a predetermined time) while the image G4 is displayed on the screen, the screen is switched to the image G5 for the sensor setting. Namely, the help display mode is changed to the sensor setting mode. In the image G5, the message of “Selection of sensor” is displayed on the first line. In addition, messages including “1) Reflection sensor,” “2) Transmission sensor,” “3) Special reflection sensor” are displayed from the second through the sixth lines. As described above with respect to FIG. 3, the label sensor 51 may be provided in the printer 101 to detect the positions of the labels L or the gap between the labels L adhered to the backing sheet of the label paper PT. The message in the image G5 shows a list of transmission-type sensors and reflection-type sensors, one of which is selected to be used for the subsequent processes.

If the CPU 11 detects a press of the decision button 154 ([ENTER]) when the “1) Reflection sensor” on the second line is selected in the image G5 of the screen display, the reflection sensor is selected to be set.

In acts A4 and A5, the CPU 11 may receive the user's operation inputted through the display/operation unit 150. As described above, the CPU 11 processes switching from the help display mode to the sensor setting mode by detecting an input of the paper feeding button (upward arrow key button) 152, the pause button 153 ([PAUSE] key), the decision button 154 ([ENTER] key), or the cancel button 154 ([CANCEL]) and changing the screen display among the images of G1 to G5 on the display/operation unit 150.

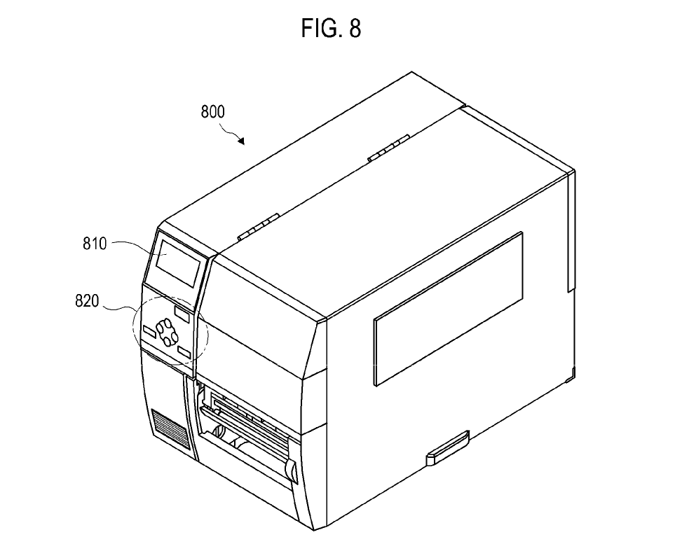

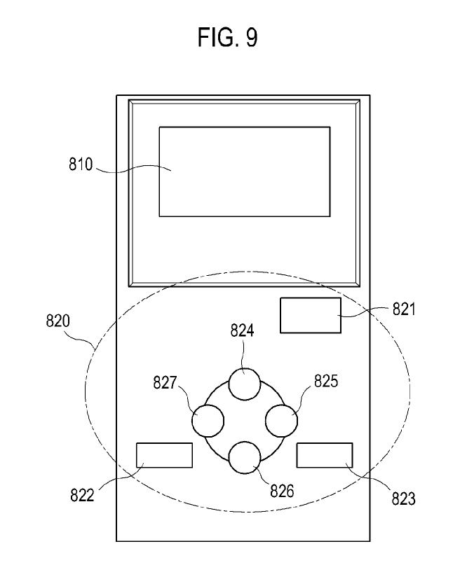

The following is another example of the process of displaying images G1 through G5 on a display/operation unit of a printer according to one embodiment. FIG. 8 is a perspective view showing the external appearance of a printer 800. The printer 800 includes a display 810 and an operation unit 820. FIG. 9 illustrates a detailed configuration of the display 810 and operation unit 820 of the printer 800. The display 810 may be a LCD display. The operation unit 820 includes a pause key 821, a cancel key 822, an enter key 823, an upper arrow key 824, a rightward arrow key 825, a downward arrow key 826, and a leftward arrow key 827. The keys included in the operation unit 820 may be implemented as mechanical input devices, but may not be limited thereto. In some embodiments, the operation unit 820 may be implemented as a touch screen in combination with the display 810. In this case, the keys included in the operation unit 820 may be implemented as graphical interface objects displayed on the screen of the display 810.

Referring to FIGS. 8 and 9, images displayed on the display 810 will be described where one of the images is switched to another depending on a user's operations being received. As described above, the image G1 shown in FIG. 7 refers to an image including the help message when detecting a paper jam error. When CPU 11 detects the occurrence of the paper jam error, the image G1 is displayed on the display 810. On the display 810, the message including “PAPER JAM” and “Correctly set paper” is displayed over 3 lines. Then, the CPU 11 may receive the user's operation inputted through the operation unit 820 (act A4).

If the CPU 11 detects a press of the rightward arrow key 825 or the enter key 823 while the image G1 is displayed on the display 810, the image G1 is switched to the image G2 and the CPU 11 controls the display 810 to show the message of the image G2. For example, the four lines of message, i.e., including “•Paper jam occurred during paper conveyance,” are displayed on the display 810.

Although for sake of explanation, the entire message is illustrated in the image G2 of FIG. 7, the actual screen displayed on the display 810 may show, for example, only the top four lines. Therefore, if the entire message to be displayed on the display 810 is more than the four lines, the screen may be scrolled to show the subsequent line (e.g., the fifth line) through the press operation of the downward arrow key 826 of the operation unit 820. For example, if the CPU 11 detects that the downward arrow key 826 is pressed down once while the image G2 (the first to the fourth lines) is displayed on the display 810, the message is scrolled by 1 line so that the second to the fifth lines of the message, i.e., including “occurred during paper conveyance” and “•Paper is not,” are displayed on the display 810.

On the other hand, if the user wants to display again the first line of the message, i.e., “•Paper jam,” in case the second to the fifth lines of the message are already displayed, the user may press the upward arrow key 824 down once. If the CPU 11 detects the press of the upward arrow key 824, the screen is scrolled upward by 1 line to show the first to the fourth lines again on the display 810.

When the CPU 11 detects a press of the rightward arrow key 825 or the enter key 823 while the image G2 is displayed on the screen, the image G2 is switched to the image G3 on the display 810. In such a case, on the display 810, the first to the fourth lines of the messages of the image G3, i.e., including “•Remove paper jammed in paper path” and “•Correctly set paper,” are displayed on the screen. In this regard, as described above, the subsequent or previous lines of the messages may be displayed when the user presses the downward arrow key 826 or the upward arrow key 824. If the CPU 11 detects the press of the downward arrow key 826 or the upward arrow key 824, the screen is scrolled to show the subsequent or previous line of the messages.

When the CPU 11 detects a press of the leftward arrow key 827 or the cancel key 822 while the image G3 is displayed on the screen, the image G3 is switched back to the image G2 on the display 810.

When the CPU 11 detects a press of the rightward arrow key 825 or the enter key 823 while the image G3 is displayed on the screen, the image G3 is switched to the image G4 on the display 810. In such case, the CPU 11 displays the four lines of the messages (the first to the fourth lines) of the image G4, i.e., including “•Restart printing with [RESTART] key” and “•Clear data by,” on the screen. On the other hand, when the CPU 11 detects a press of the leftward arrow key 827 or the cancel button 822 while the image G4 is displayed on the screen, the image G4 is switched back to the previous image G3 so that the image G3 is displayed on the display 810.

When the CPU 11 detects that the pause key 821 is pressed for a long time (i.e. when the CPU 11 detects that the pause key 821 is pressed for a predetermined time) while the image G4 is displayed on the screen, the screen is switched to the image G5 for the sensor setting. By performing such switching of the images, the help display mode is changed to the sensor setting mode. In the image G5, the message of “Selection of sensor” is displayed on the first line. In addition, “1) Reflection sensor,” “2) Transmission sensor,” “3) Special reflection sensor” are displayed respectively on the second to the sixth lines. As described above with respect to FIG. 3, the label sensor 51 may be provided in the printer 101 to detect the positions of the labels L or the gap between the labels L adhered to the backing sheet of the label paper PT. The message in the image G5 shows a list of transmission-type sensors and reflection-type sensors, one of which is selected to be used for the subsequent processes.

If the CPU 11 detects a press of the enter key 823 when the “1) Reflection sensor” on the second line is selected in the image G5 of the screen display, the reflection sensor is selected to be set.

In acts A3 to A5, the CPU 11 may receive the user's operation inputted through the operation unit 820. As described above, the CPU 11 processes switching from the help display mode to the sensor setting mode by detecting the input of the pause key 821, the cancel key 822, the enter key 823, the upward arrow key 824, the rightward arrow key 825, the downward arrow key 826, or the leftward arrow key 827 and changing the screen display among the images of G1 to G5 on the display 810.

In addition, according to an alternative embodiment, the screen scroll in the images of G2 and G3 may be performed in such a manner that the message is scrolled by more than one line if the CPU 11 detects that the downward arrow key 826 is pressed down once. For example, when the CPU 11 detects that the downward arrow key 826 is pressed down once, the messages may be scrolled by two lines. Namely, when the CPU 11 detects that the downward arrow key 826 is pressed down once while the first to the four lines of message, i.e., including “•Paper jam occurred during paper conveyance” and “•Paper is not,” are displayed on the display 810 (as illustrated in the image G2 in FIG. 7), the screen is scrolled down to show the third to the sixth lines of message, i.e., including “during paper conveyance” and “Paper is not correctly set” on the display 810. In this situation, if the user wants to see the first line of the message again, the user may press the upward arrow key 824 once. Thus, when the CPU 11 detects that the upward arrow key 824 is pressed down once, two lines of the message are scrolled up to show the first to the fourth lines of the messages on the display 810.

The program executed in the printer 101 of the present embodiment may be provided to be pre-stored in the flash memory 14, the ROM and so forth. Alternatively, the program executed in the printer 101 of the present embodiment may be provided to be recorded in a computer-readable recording medium such as a CD-ROM, a flexible disk (FD), a CD-R or a DVD (Digital Versatile Disk) in a form of an installable or executable file.

In addition, the program executed in the printer 101 of the present embodiment may be stored in a computer connected to the printer 101 via a network such as the Internet so that the program can be down-loaded from the computer via the network. Moreover, the program executed in the printer 101 of the present embodiment may be provided or distributed via a network such as the Internet.

The program executed in the printer 101 of the present embodiment may be organized into modules implementing or controlling the respective units described above (e.g., the display and the mode switching unit) in software. Thus, in an actual hardware, when the CPU (or the processor) reads and executes the program from the ROM, the respective units may be loaded to a main memory unit so that the display and the mode switching unit can be created in the main memory unit.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) in the apparatus.

While certain embodiments have been described above, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer, comprising:
a memory configured to store a message to be displayed in a help display mode to handle an error detected in an execution mode and to store a setting mode in which a setting program associated with the message is performed;
a display configured to display the message;
an operation unit configured to receive a user's operation; and
a mode switching unit configured to switch an operation mode from the help display mode to the setting mode associated with the message when the operation unit receives a specified operation while the message is displayed in the help display mode.

2. The printer of claim 1, further comprising a determination unit configured to determine a type of error detected in the execution mode, and
wherein, for each type of error detected in the execution mode, the memory stores the message and the setting mode associated with the message, and
wherein the display displays the message corresponding to the determined type of error.

3. The printer of claim 1, wherein the display displays information on the setting mode associated with the message while displaying the message.

4. The printer of claim 1, wherein upon receiving a specified operation in the operation unit for a predetermined period, the mode switching unit switches the operation mode from help display mode to the setting mode associated with the message.

5. The printer of claim 1, wherein upon receiving a specified operation in the operation unit, the display scrolls upward or downward the message.

6. The printer of claim 4, where the operation unit includes an upward arrow key for scrolling the message upward, and a downward arrow key for scrolling the message downward,
wherein the display scrolls the message upward upon detecting an operation by the upward arrow key and scrolls the message downward upon detecting an operation by the downward arrow key.

7. The printer of claim 1, wherein the memory further stores a message table including messages corresponding to respective types of errors and information linked to setting modes associated with the respective messages,
wherein the display acquires the message corresponding to the detected error and the mode switching unit acquires the information relating to the setting mode associated with the message by referring to the message table.

8. The printer of claim 7, wherein the messages stored in the message table indicate countermeasures against the respective types of errors, and the information linked to setting modes indicate setting modes to enter after the causes of the errors are resolved according to the messages.

9. The printer of claim 1, wherein the display is implemented in form of a touch screen and the operation unit is implemented in form of graphical interfaces displayed on the display.

10. The printer of claim 1, wherein when the type of the detected error is a paper jam, the setting mode associated with the message is a sensor setting mode in which a sensor is selected in association with the type of the detected error.

11. A printing method, comprising:
storing, in a memory, a message to be displayed in a help display mode to handle an error detected in an execution mode and a setting mode in which a setting associated with the message is performed;
displaying the message in a display;
receiving a user's operation in an operation unit; and
switching, in a mode switching unit, an operation mode from the help display mode to the setting mode associated with the message when the operation unit receives a specified operation while the message is displayed in the help display mode.

12. The method of claim 11, further comprising:
determining a type of error detected in the execution mode;
storing, for the error detected in the execution mode, the message and the setting mode associated with the message in the memory; and
displaying the message corresponding to the determined type of error in the display.

13. The method of claim 11, further comprising displaying information on the setting mode associated with the message while displaying the message in the display.

14. The method of claim 11, further comprising, upon receiving a specified operation in the operation unit for a predetermined period, switching the operation mode from help display mode to the setting mode associated with the message in the mode switching unit.

15. The method of claim 11, further comprising, upon receiving a specified operation in the operation unit, scrolling upward or downward the message in the display.

16. The method of claim 11, further comprising:
storing in the memory a message table including messages corresponding to respective types of errors and information linked to setting modes associated with the respective messages,
wherein the display acquires the message corresponding to the detected error and the mode switching unit acquires the information relating to the setting mode associated with the message by referring to the message table.

17. The method of claim 16, wherein the messages stored in the message table indicate countermeasures against the respective types of errors, and the information linked to setting modes indicate setting modes to enter after the causes of the errors are resolved according to the messages.

18. The method of claim 11, wherein when the type of the detected error is a paper jam, the setting mode associated with the message is a sensor setting mode in which a sensor is selected in association with a type of detected error.

19. A computer-readable storage medium storing instructions that, when executed by a computer, cause the computer to perform a printing method comprising:
storing, in a memory, a message to be displayed in a help display mode to handle an error detected in an execution mode and a setting mode in which a setting program associated with the message is performed;
displaying the message in a display;
receiving a user's operation in an operation unit; and
switching, in a mode switching unit, an operation mode from the help display mode to the setting mode associated with the message when the operation unit receives a specified operation while the message is displayed in the help display mode.

20. The computer-readable storage medium of claim 19, the method further comprising:
determining a type of error detected in the execution mode;
storing, for the error detected in the execution mode, the message and the setting mode associated with the message in the memory; and
displaying the message corresponding to the determined type of error in the display.
